(19) United States
(12) Patent Application Publication
(10) Pub. No.: US 2024/0223898 A1
(43) Pub. Date: Jul. 4, 2024

(54) LENS DRIVING APPARATUS AND METHOD OF MANUFACTURING LENS DRIVING APPARATUS

(71) Applicant: Samsung Electro-Mechanics Co., Ltd., Suwon-si (KR)

(72) Inventors: Ahhyeon IM, Suwon-si (KR); Mansu KIM, Suwon-si (KR); Sangjin LEE, Suwon-si (KR)

(73) Assignee: Samsung Electro-Mechanics Co., Ltd., Suwon-si (KR)

(21) Appl. No.: 18/210,951

(22) Filed: Jun. 16, 2023

(30) Foreign Application Priority Data
Dec. 29, 2022 (KR) 10-2022-0189351

(51) Int. Cl. H04N 23/68; G03B 17/12; H04N 23/54; H04N 23/55

(52) U.S. Cl. CPC H04N 23/685; G03B 17/12; H04N 23/54; H04N 23/55; G03B 2205/0069

(57) ABSTRACT

A lens driving apparatus includes a lens holder accommodating a lens barrel; an optical image stabilization (OIS) driving magnet coupled to an outer surface of the lens holder; a holder-side fixing part protruding from the outer surface of the lens holder, and a magnet-side fixing part disposed in the OIS driving magnet and coupled with the holder-side fixing part.

### CROSS-REFERENCE TO RELATED APPLICATIONS

This application claims the benefit under 35 USC 119(a) of Korean Patent Application No. 10-2022-0189351 filed on Dec. 29, 2022, in the Korean Intellectual Property Office the entire disclosure of which is incorporated herein by reference for all purposes.

### BACKGROUND

### 1. Field

The present disclosure relates to a lens driving apparatus and a method of manufacturing a lens driving apparatus.

### 2. Description of Related Art

The supply and use of electronic devices have rapidly increased due to remarkable developments of information and communication technology and semiconductor technology.

These electronic devices tend to provide various functions combined in a single device rather than remaining in their traditional unique domains.

In recent years, a camera module has become a basic feature in a portable electronic device such as a smartphone, a tablet personal computer (PC), or a laptop computer, and an autofocus (AF) function, an optical image stabilization (OIS) function, and a zoom function may be added to the camera module of such a portable electronic device.

A conventional lens driving apparatus may have a complicated manufacturing process, an excessive component cost, or an excessive manufacturing cost, as well as an increased process time and an increased product defect rate as different parts are separately manufactured and then assembled together.

The above information disclosed in this Background section is only for enhancement of understanding of the background of the disclosure of this application, and therefore it may contain information that does not constitute prior art that is already known to a person of ordinary skill in the art.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a lens driving apparatus includes a lens holder accommodating a lens barrel; an optical image stabilization (OIS) driving magnet coupled to an outer surface of the lens holder; a holder-side fixing part protruding from the outer surface of the lens holder; and a magnet-side fixing part disposed in the OIS driving magnet and coupled with the holder-side fixing part.

The lens holder and the holder-side fixing part may be integrally formed with each other.

The holder-side fixing part of the lens holder may be an insert injection molded part inserted into and fixed to the magnet-side fixing part of the OIS driving magnet by insert injection molding.

The holder-side fixing part may include a protruding pillar having a fixed end fixed to the outer surface of the lens holder and a free end protruding outward from the outer surface of the lens holder, and the magnet-side fixing part may include a hole into which the protruding pillar is inserted.

The protruding pillar may be tapered so that a cross-sectional area of the protruding pillar at the free end is larger than a cross-sectional area of the protruding pillar at the fixed end.

The protruding pillar may be a bent pillar bent at the free end.

The magnet-side fixing part may be a cut-out part disposed at one edge of the OIS driving magnet.

The protruding pillar may be further bent at the fixed end.

A smallest cross-sectional area of the protruding pillar may be between the fixed end and the free end.

The protruding pillar may be tapered from either one or both of the fixed end and the free end to a point where the pillar has the smallest cross-sectional area.

The holder-side fixing part may include at least one outward protrusion protruding outward from the outer surface of the lens holder.

The magnet-side fixing part may include a cut-out part disposed at one edge of the OIS driving magnet.

The magnet-side fixing part may include a cut-out part disposed at one corner of the OIS driving magnet.

The magnet-side fixing part may include a first concave stepped part formed in one edge of the OIS driving magnet facing the outer surface of the lens holder, and the holder-side fixing part may include a first convex stepped part coupled with the first concave stepped part of the magnet-side fixing part.

The magnet-side fixing part may further include a second concave stepped part formed in another edge of the OIS driving magnet opposite to the edge in which the first concave stepped part is formed.

In another general aspect, a method of manufacturing a lens driving apparatus includes mounting an unmagnetized optical image stabilization (OIS) driving magnet including a magnet-side fixing part in a lens holder mold; injecting an injection material into the lens holder mold to form an insert injection molded lens holder having a holder-side fixing part coupled with the magnet-side fixing part; and magnetizing the unmagnetized OIS driving magnet.

The injecting of the injection material into the lens hold mold may form the holder-side fixing part so that the holder-side fixing part protrudes from an outer surface of the lens holder and fills the magnet-side fixing part.

In another general aspect, a lens driving apparatus includes a lens holder accommodating a lens barrel; an optical image stabilization (OIS) driving magnet mounted on the lens holder and including a magnet-side fixing part; and a holder-side fixing part mounted on the lens holder and filling the magnet-side fixing part.

The magnet-side fixing part may be a hole spaced apart from every edge of the OIS driving magnet and extending through the OIS driving magnet, and the holder-side fixing part may be a protruding pillar protruding from the lens holder and filling the hole.

The magnet-side fixing part may be a cut-out part formed in an edge of the OIS driving magnet and extending through the OIS driving magnet, and the holder-side fixing part may be a protruding pillar protruding from the lens holder and filling the cut-out part.

The magnet-side fixing part may be a concave stepped part formed in an edge of the OIS driving magnet and extending partway through the OIS driving magnet, and the holder-side fixing part may be a convex stepped part protruding from the lens holder and filling the concave stepped part.

Other features and aspects will be apparent from the following detailed description, the drawings, and the claims.

### BRIEF DESCRIPTION OF THE DRAWINGS

FIG. 1 is a perspective view showing an appearance of a camera module according to an embodiment.

FIG. 2 is an exploded perspective view schematically showing the camera module shown in FIG. 1.

FIG. 3 is an exploded perspective view showing a lens holder of the camera module shown in FIG. 2.

FIG. 4 is an assembled perspective view of the lens holder shown in FIG. 3.

FIG. 5 is a partial cross-sectional view taken along the line V-V′ of FIG. 4.

FIG. 6 is an exploded perspective view of a lens holder applied to a lens driving apparatus of another embodiment.

FIG. 7 is a partial cross-sectional view taken along the line VII-VII′ of FIG. 6.

FIG. 8 is an exploded perspective partial view of a lens holder applied to a lens driving apparatus of another embodiment.

FIG. 9 is a partial cross-sectional view taken along the line IX-IX′ of FIG. 8.

FIG. 10 is an exploded perspective partial view of a lens holder applied to a lens driving apparatus of another embodiment.

FIG. 11 is a partial cross-sectional view taken along the line XI-XI′ of FIG. 10.

FIG. 12 is an exploded perspective partial view of a lens holder applied to a lens driving apparatus of another embodiment.

FIG. 13 is a partial cross-sectional view taken along the line XIII-XIII′ of FIG. 12.

FIG. 14 is an exploded perspective partial view of a lens holder applied to a lens driving apparatus of another embodiment.

FIG. 15 is a partial cross-sectional view taken along the line XV-XV′ of FIG. 14.

FIG. 16 is an exploded perspective partial view of a lens holder applied to a lens driving apparatus of another embodiment.

FIG. 17 is a partial cross-sectional view taken along the line XVII-XVII′ of FIG. 16.

FIG. 18 is an exploded perspective view of a lens holder applied to a lens driving apparatus of another embodiment.

FIG. 19 is an exploded perspective partial view of a lens holder applied to a lens driving apparatus of another embodiment.

FIG. 20 is an exploded perspective partial view of a lens holder applied to a lens driving apparatus of another embodiment.

FIG. 21 is an exploded perspective partial view of a lens holder applied to a lens driving apparatus of another embodiment.

FIG. 22 is a partial cross-sectional view taken along the line XXII-XXII′ of FIG. 21.

FIG. 23 is an exploded perspective view of a lens holder applied to a lens driving apparatus of another embodiment.

FIG. 24 is a partial cross-sectional view taken along the line XXIV-XXIV′ of FIG. 23.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Further, since sizes and thicknesses of constituent members shown in the accompanying drawings are arbitrarily given for better understanding and ease of description, this disclosure is not limited to the illustrated sizes and thicknesses. In the drawings, the thicknesses of layers, films, panels, regions, etc., are exaggerated for clarity. In the drawings, for better understanding and ease of description, the thicknesses of some layers and areas are exaggerated.

Further, throughout the specification, an expression “a plan view” may indicate a case where an object is viewed from the top, and an expression “a cross-sectional view” may indicate a case where a cross section of an object taken along a vertical direction is viewed from the side.

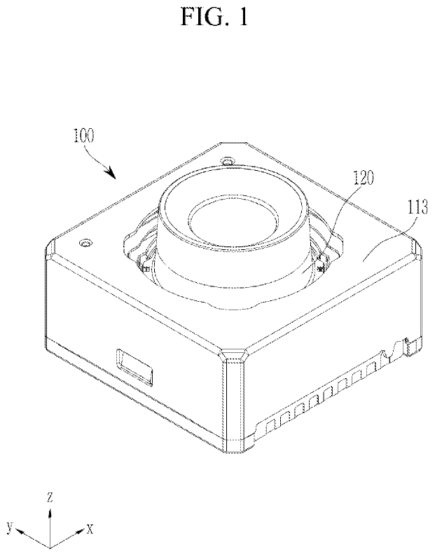

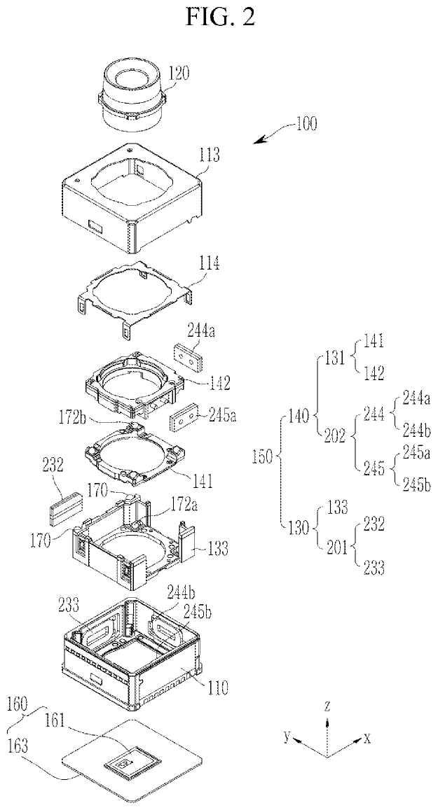

FIG. 1 is a perspective view showing an appearance of a camera module according to an embodiment; and FIG. 2 is an exploded perspective view schematically showing the camera module shown in FIG. 1.

Referring to FIGS. 1 and 2, a camera module 100 according to an embodiment may include a lens barrel 120, a lens driving unit 150 moving the lens barrel 120, and an image sensor unit 160 converting light incident thereto through the lens barrel 120 into an electrical signal. In addition, the lens barrel 120 and the lens driving unit 150 may be accommodated in a housing 110, and the housing 110 may be covered with a cover 113.

The lens barrel 120 may have a hollow cylindrical shape for a plurality of lenses capturing an image of a subject to be accommodated therein, and the plurality of lenses may be aligned along an optical axis and mounted in the lens barrel 120. The number of the plurality of lenses mounted in the lens barrel 120 may depend on a design of the lens barrel 120, and each lens may have an optical characteristic such as the same or different refractive index.

The optical axis may be set to a central axis of the lens accommodated in the lens barrel 120, and an optical axis direction refers to a direction parallel to this central axis. In the drawing, the optical axis is set as a z-axis, and an x-axis and a y-axis are set in directions perpendicular to the optical axis. The x-axis and y-axis are set perpendicular to each other.

The lens driving unit 150 may be a device moving the lens barrel 120, and may include an autofocus (AF) unit 130 adjusting a focus and an optical image stabilization (OIS) unit 140 correcting a hand trembling or an unstable image.

For example, the lens driving unit 150 may adjust the focus by moving the lens barrel 120 in the optical axis direction by using the AF unit 130, and correct the unstable image during capturing the image by moving the lens barrel 120 in a direction perpendicular to the optical axis direction by using the OIS unit 140.

The AF unit 130 may include a carrier 133 accommodating the lens barrel 120 and an AF driving unit 201 generating a driving force for the lens barrel 120 and the carrier 133 to be moved in the optical axis direction. The AF driving unit 201 may include an AF driving magnet 232 and an AF driving coil 233.

When power is applied to the AF driving coil 233, the carrier 133 may be moved in the optical axis direction relative to the housing 110 by an electromagnetic force generated between the AF driving magnet 232 and the AF driving coil 233. The lens barrel 120 may be accommodated in the carrier 133, and the focus may thus be adjusted while the lens barrel 120 is also moved in the optical axis direction by the movement of the carrier 133.

Rolling members 170 may be disposed between the carrier 133 and the housing 110 to reduce friction between the carrier 133 and the housing 110 when the carrier 133 is moved. Each of the rolling members 170 may have a ball shape and may be disposed on each of two sides of a center of one side of the carrier 133.

The OIS unit 140 may correct a blurred image or an unstable video due to a factor such as a user's hand trembling when capturing the image or video. That is, when the image being captured is unstable due to the user's hand trembling or other disturbance, the OIS unit 140 may stabilize the image by allowing the lens barrel 120 to be displaced relative to the housing 110 to counteract the trembling. For example, the OIS unit 140 may stabilize the image by moving the lens barrel 120 in either one or both of a first and a second direction (or an x-axis direction and a y-axis direction) perpendicular to the optical axis direction.

The OIS unit 140 may include a guide member 131 guiding the movement of the lens barrel 120 and an OIS driving unit 202 generating a driving force for the guide member 131 to be moved in the direction perpendicular to the optical axis direction.

The guide member 131 may include a support frame 141 and a lens holder 142. The support frame 141 and the lens holder 142 may be accommodated in the carrier 133, aligned in the optical axis direction, and serve to guide the movement of the lens barrel 120. The support frame 141 and the lens holder 142 may each have a central opening into which the lens barrel 120 may be inserted, and the lens barrel 120 may be coupled and fixed to the lens holder 142 through the central opening. For example, the lens holder 142 may have a frame structure having four corners, and the support frame 141 may also have a frame structure having four corners corresponding thereto.

The OIS driving unit 202 may include a first OIS driving unit 244 and a second OIS driving unit 245, and the first OIS driving unit 244 may generate a driving force in the first direction (i.e., the x-axis direction in the drawing) perpendicular to the optical axis, and the second OIS driving unit 245 may generate a driving force in a second direction (i.e., the y-axis direction in the drawing) perpendicular to the optical axis and the first direction described above. The first and second OIS driving units 244 and 245 may respectively include OIS driving magnets 244a and 245a and OIS driving coils 244b and 245b.

The OIS driving magnets 244a and 245a of the first and second OIS driving units 244 and 245 may be mounted in the lens holder 142, and the OIS driving coils 244b and 245b respectively facing the OIS driving magnets 244a and 245a may be disposed on a circuit board (not shown) and fixedly mounted in the housing 110.

A plurality of first ball members 172a and a plurality of second ball members 172b may be disposed to support the OIS unit 140. The plurality of first ball members 172a and the plurality of second ball members 172b may serve to guide the lens holder 142 in an image stabilization process. In addition, the plurality of first ball members 172a and the plurality of second ball members 172b may also function to maintain a predetermined spacing between the carrier 133 and the lens holder 142.

The image sensor unit 160 may be a device converting light incident thereto through the lens module 120 into the electrical signal. For example, the image sensor unit 160 may include an image sensor 161 and a circuit board 163 connected to the image sensor 161, and may further include an infrared filter. The infrared filter may block light in an infrared region in the light incident thereto through the lens barrel 120.

The image sensor 161 may convert the light incident thereto through the lens barrel 120 into the electrical signal. For example, the image sensor 161 may be a charge-coupled device (CCD) or a complementary metal-oxide semiconductor (CMOS) device. The electrical signal converted by the image sensor 161 may be output as an image through a display unit of an electronic device in which the camera module 100 may be mounted. The image sensor 161 may be fixed to the circuit board 163, and electrically connected to the circuit board 163.

The lens barrel 120 and the lens driving unit 150 may be accommodated in an inner space of the housing 110. For example, the housing 110 may have a box shape having open tops and bottoms. The image sensor unit 160 is disposed on the bottom of the housing 110.

The cover 113 may be coupled with the housing 110 to surround an outer surface of the housing 110, and protect internal components of the camera module 100. In addition, the cover 113 may function to shield electromagnetic waves. For example, the cover 113 may shield electromagnetic waves generated in the camera module 100 to prevent the electromagnetic waves from affecting other electronic components in the electronic device.

In addition, the AF driving unit 201 and the OIS driving unit 202 may each further include a sensing unit (not shown) detecting the movement of the lens barrel 120. The sensing units of the AF driving unit 201 and the OIS driving unit 202 may each have a shape of an integrated circuit (IC) package that may be controlled by a control unit (not shown) included in the circuit board 163 connected to the image sensor 161.

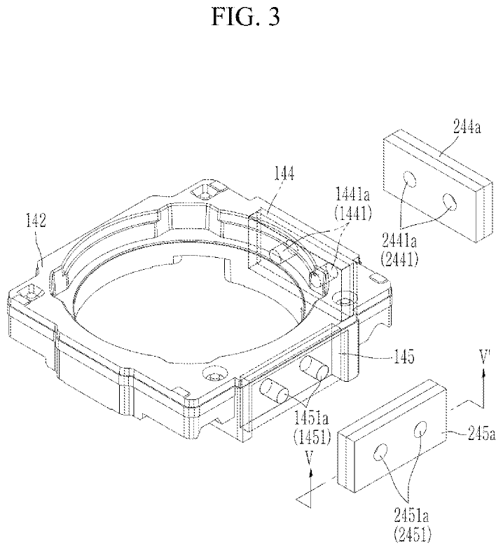

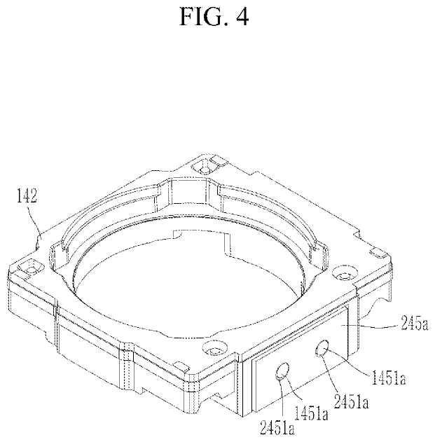

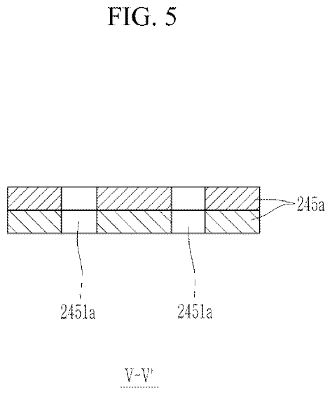

FIG. 3 is an exploded perspective view showing the lens holder of the camera module shown in FIG. 2; FIG. 4 is an assembled perspective view of the lens holder shown in FIG. 3; and FIG. 5 is a partial cross-sectional view taken along the line V-V′ of FIG. 4.

Referring to FIGS. 3 and 4, the lens holder 142 according to this embodiment may include first and second magnet coupling parts 144 and 145. The first and second OIS driving magnets 244a and 245a may be fixedly mounted to the first and second magnet coupling parts 144 and 145 of the lens holder 142. The first and second magnet coupling parts 144 and 145 may have a recessed shape for accommodating the first and second OIS driving magnets 244a and 245a.

Each of the first and second OIS driving magnets 244a and 245a may have a first surface adjacent to an outer surface of the lens holder 142 and a second surface opposite to the first surface. The first and second surfaces of each of the first and second OIS driving magnets 244a and 245a may have magnetic poles that are opposite to each other.

The first and second OIS driving magnets 244a and 245a may be integrally coupled with the lens holder 142. To this end, when manufacturing the lens holder 142, the lens holder 142 integrally coupled with the first and second OIS driving magnets 244a and 245a may be manufactured by inserting an unmagnetized magnet into a lens holder mold and performing insert-injection molding to form the lens holder 142.

First and second holder-side fixing parts 1441 and 1451 may be disposed in the first and second magnet coupling parts 144 and 145 of the lens holder 142, and first and second magnet-side fixing parts 2441 and 2451 may be disposed in the first and second OIS driving magnets 244a and 245a. The first and second holder-side fixing parts 1441 and 1451 and the first and second magnet-side fixing parts 2441 and 2451 may have shapes complementary to each other and coupled with each other. The first and second holder-side fixing parts 1441 and 1451 may protrude from the outer surface of the lens holder 142 and be coupled with the first and second magnet-side fixing parts 2441 and 2451.

The first and second holder-side fixing parts 1441 and 1451 may be formed by insert injection molding in which an injection material is injected into the lens holder mold after mounting unmagnetized first and second OIS driving magnets 244a and 245a in the lens holder mold, and as a result of the insert injection molding, the lens holder 142 and the first and second OIS driving magnets 244a and 245a may be integrally coupled with each other.

Referring to FIGS. 4 and 5, in the lens driving unit 150 according to this embodiment, protruding pillars each having a fixed end fixed to the outer surface of the lens holder 142 and a free end protruding from the fixed end to the outside of the lens holder 142 may be formed as holder-side fixing parts 1441a and 1451a. This embodiment exemplifies the protruding pillars as cylinders. However, the protruding pillars may have various shapes including triangular pillars and square pillars that also fall within the scope of the present disclosure.

Holes coupled with the holder-side fixing parts 1441a and 1451a each having a protruding pillar shape may be formed as magnet-side fixing parts 2441a and 2451a. Each of these holes formed as the magnet-side fixing parts 2441a and 2451a may be a through hole passing through the OIS driving magnets 244a and 245a from the first surface to second surface thereof.

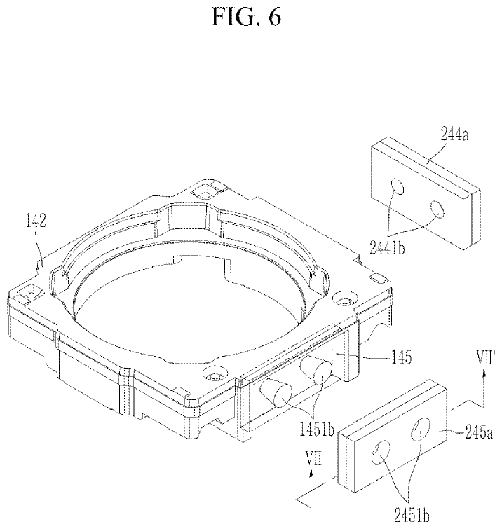

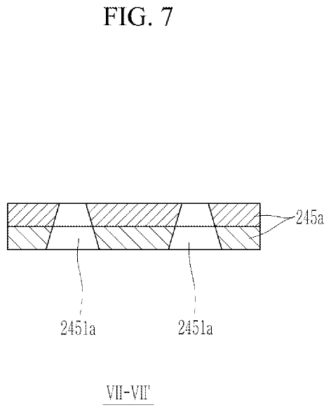

FIG. 6 is an exploded perspective view of a lens holder applied to a lens driving apparatus of another embodiment; and FIG. 7 is a partial cross-sectional view taken along the line VII-VII′ of FIG. 6.

Referring to FIGS. 6 and 7, each of the holder-side fixing parts 1441b and 1451b of the lens holder 142 in this embodiment may have a smallest cross-sectional area at a fixed end at the outer surface of the lens holder 142 and a largest cross-sectional area at a free end outside the lens holder 142. Therefore, each of the holder-side fixing parts 1441b and 1451b may be a tapered protruding pillar whose diameter gradually increases from the fixed end to free end thereof. The tapered protruding pillar may have a circular cross section.

Each of the first and second magnet-side fixing parts 2441b and 2451b coupled with the holder-side fixing parts 1441b and 1451b in this embodiment may be a tapered hole having a smallest cross-sectional area at the first surface of the first and second OIS driving magnets 244a and 245a and a largest cross-sectional area at the second surface of the first and second OIS driving magnets 244a and 245a, and may be a tapered through hole passing between the first surface and the second surface.

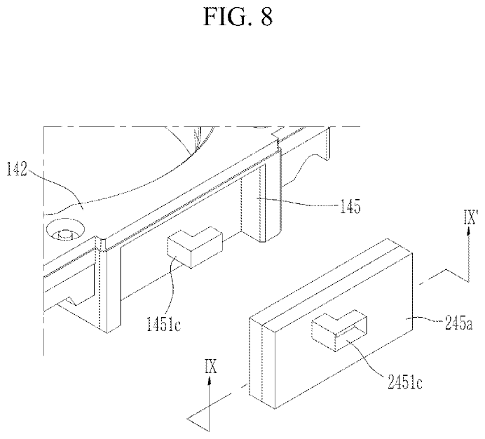

FIGS. 8 to 17 show and describe only the second OIS driving magnet 245a and the second magnet coupling part 145. However, the first OIS driving magnet 244a and the first magnet coupling part 144 may have the same structure as the second OIS driving magnet 245a and the second magnet coupling part 145, which also falls within the scope of the present disclosure.

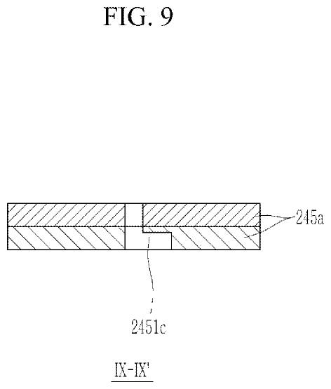

FIG. 8 is an exploded perspective partial view of a lens holder applied to a lens driving apparatus of another embodiment; and FIG. 9 is a partial cross-sectional view taken along the line IX-IX′ of FIG. 8.

Referring to FIGS. 8 and 9, a holder-side fixing part 1451c of the lens holder 142 in this embodiment may be a bent pillar bent at an outer free end thereof. This embodiment exemplifies the bent pillar as having a rectangular cross section. However, the pillar may have various cross-sectional shapes including circular, triangular, and pentagonal shapes, which also fall within the scope of the present disclosure.

A magnet-side fixing part 2451c of the OIS driving magnet 245a coupled with the bent pillar may be a hole bent in a second half of the OIS driving magnet 245a, and this hole may be a through hole having a wide portion at the second surface of the OIS driving magnet 245a.

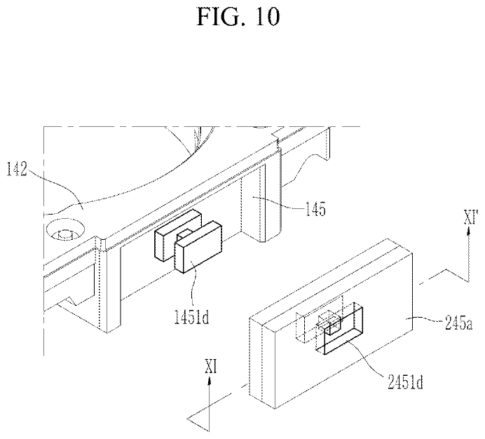

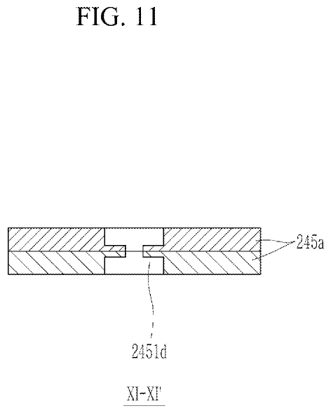

FIG. 10 is an exploded perspective partial view of a lens holder applied to a lens driving apparatus of another embodiment; and FIG. 11 is a partial cross-sectional view taken along the line XI-XI′ of FIG. 10.

Referring to FIGS. 10 and 11, a holder-side fixing part 1451d of the lens holder 142 may have a wide cross-sectional area at each of a fixed end and a free end thereof, and may have a minimum cross-sectional area at a point between the fixed end and the free end. For example, as shown in FIG. 10, the holder-side fixing part 1451d may have a wide structure located at each of the fixed end and the free end, and a narrow pillar located between the wide structures at the fixed end and the free end and connecting the wide structures with each other. This embodiment exemplifies wide structures at the fixed end and the free end as each having a rectangular cross section. However, the wide structures may have various shapes including circular, triangular, and pentagonal shapes, which also falls within the scope of the present disclosure.

A magnet-side fixing part 2451d of the OIS driving magnet 245a coupled with the holder-side fixing part 1451d may be a hole having a wide cross-sectional area at each of the first surface and the second surface of the OIS driving magnet 245a, and having a minimum cross-sectional area at a portion between the first surface and the second surface, and this hole may be a through hole.

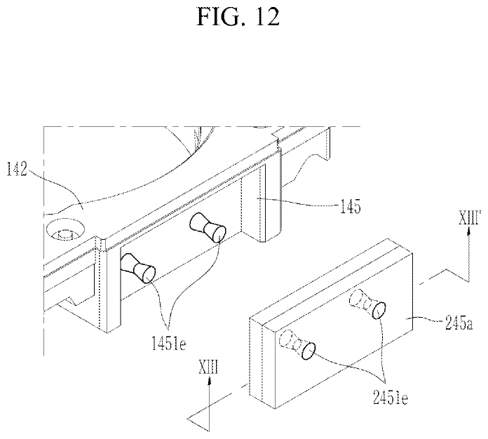

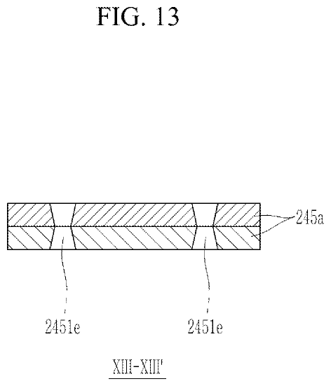

FIG. 12 is an exploded perspective partial view of a lens holder applied to a lens driving apparatus of another embodiment; and FIG. 13 is a partial cross-sectional view taken along the line XIII-XIII′ of FIG. 12.

Referring to FIGS. 12 and 13, a holder-side fixing part 1451e of the lens holder 142 may have a wide cross-sectional area at each of ta fixed end and a free end thereof, and may have a minimum cross-sectional area at a point between the fixed end and the free end. The holder-side fixing part 1451e may be tapered from a point of the minimum cross-sectional area toward the fixed end and the free end.

A magnet-side fixing part 2451e of the OIS driving magnet 245a coupled with the holder-side fixing part 1451e may be a hole or through hole having a wide cross-sectional area at each of the first surface and the second surface of the OIS driving magnet 245a, and having a minimum cross-sectional area at a portion between the first surface and the second surface. The through hole may be tapered from a point of the minimum cross-sectional area toward the first surface and second surface of the magnet-side fixing part 2451e.

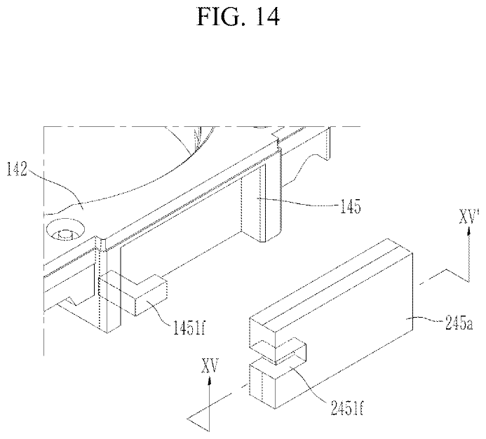

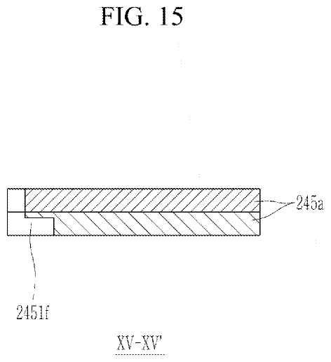

FIG. 14 is an exploded perspective partial view of a lens holder applied to a lens driving apparatus of another embodiment; and FIG. 15 is a partial cross-sectional view taken along the line XV-XV′ of FIG. 14.

Referring to FIG. 14 and FIG. 15, a holder-side fixing part 1451f of the lens holder 142 may be a protruding pillar located at a left side or a right side of the magnet coupling part 145 of the lens holder 142, and the protruding pillar may be a bent pillar bent at a free end thereof.

A magnet-side fixing part 2451f coupled with the holder-side fixing part 1451f may be formed at a left side or a right side of the OIS driving magnet 245a corresponding to the left side or the right side of the magnet coupling part 145 at which the holder-side fixing part 1451f is formed. The magnet-side fixing part 2451f may be a cut-out part bent at a second surface of the OIS driving magnet 245a. The cut-out part may pass through the OIS driving magnet 245a from the first surface to the second surface thereof.

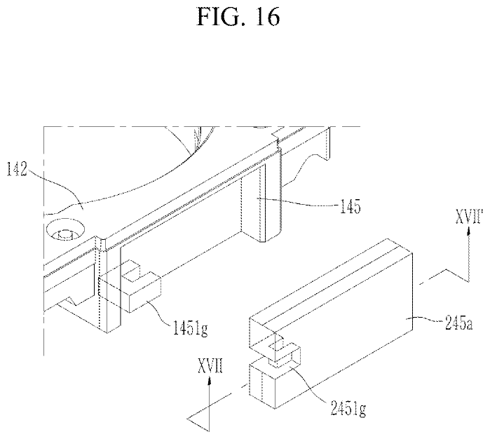

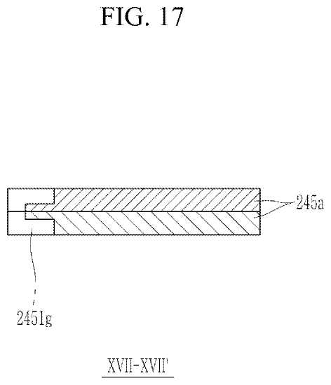

FIG. 16 is an exploded perspective partial view of a lens holder applied to a lens driving apparatus of another embodiment; and FIG. 17 is a partial cross-sectional view taken along the line XVII-XVII′ of FIG. 16.

Referring to FIGS. 16 and 17, a holder-side fixing part 1451g of the lens holder 142 according to this embodiment may be a double bent pillar in which the holder-side fixing part 1451f shown in FIG. 14 is also bent at a fixed end thereof.

A magnet-side fixing part 2451g coupled with the holder-side fixing part 1451g of the lens holder 142 may be a hole in which the magnet-side fixing part 2451f shown in FIGS. 14 and 15 is also bent at the first surface of the OIS driving magnet 245a.

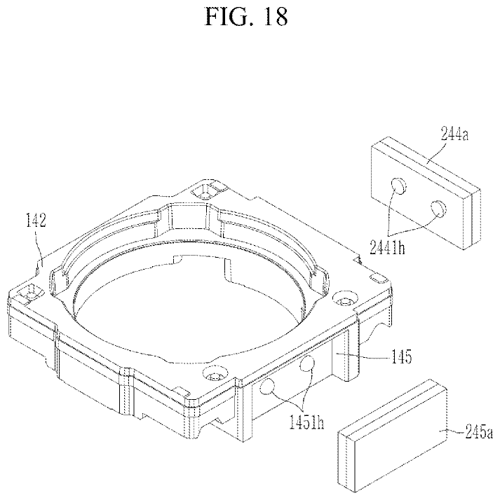

FIG. 18 is an exploded perspective view of a lens holder applied to a lens driving apparatus of another embodiment.

Referring to FIG. 18, a holder-side fixing part 1451h of the lens holder 142 may be outward protrusions protruding toward the outside of the lens holder 142. Outward protrusion receiving grooves may be formed in each of the OIS driving magnets 244a and 245a as a magnet-side fixing part 2441h coupled with a holder-side fixing part (not shown), which is the outward protrusions located in the first magnet fixing part 144, and a magnet-side fixing part (not shown) coupled with the holder-side fixing part 1451h, which is the outward protrusions located in the second magnet fixing part 145.

In another embodiment, inward protrusions protruding toward the lens holder 142 may be formed as the magnet-side fixing parts of the OIS driving magnets 244a and 245a, and inward protrusion receiving grooves may be formed as the holder-side fixing part of the lens holder 142.

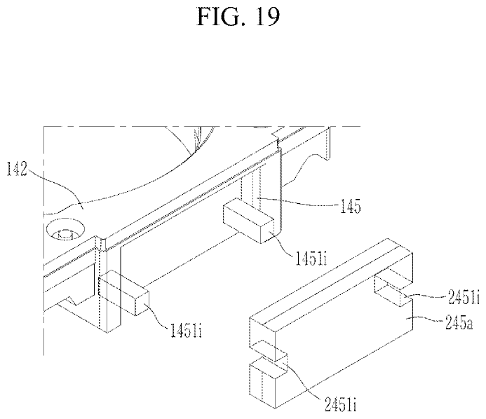

FIGS. 19 to 24 show and describe only the second OIS driving magnet 245a and the second magnet coupling part 145. However, the first OIS driving magnet 244a and the first magnet coupling part 144 may have the same structure as the second OIS driving magnet 245a and the second magnet coupling part 145, which also falls within the scope of the present disclosure.

FIG. 19 is an exploded perspective partial view of a lens holder applied to a lens driving apparatus of another embodiment.

Referring to FIG. 19, a holder-side fixing part 1451i of the lens holder 142 may be protruding pillars disposed at each of a left side and a right side of the magnet coupling part 145 of the lens holder 142. Cut-out parts may be formed at each of a right side and a left side of the OIS driving magnet 245a as a magnet-side fixing part 2451i coupled with the holder-side fixing part 1451i. The cut-out parts may pass through the OIS driving magnet 245a from the first surface to the second surface thereof.

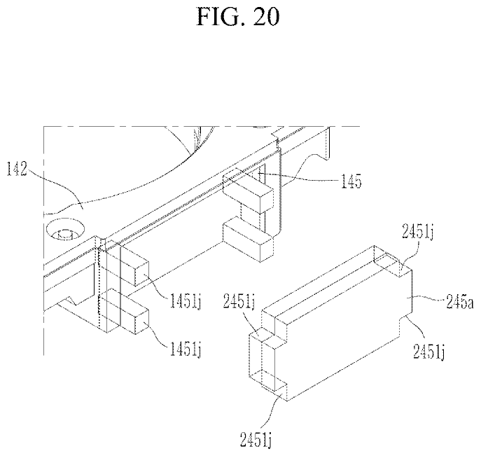

FIG. 20 is an exploded perspective partial view of a lens holder applied to a lens driving apparatus of another embodiment.

Referring to FIG. 20, a holder-side fixing part 1451j of the lens holder 142 may be a protruding pillar disposed at at least one corner of the magnet coupling part 145 of the lens holder 142, and may be protruding pillars formed at all four corners of the magnet coupling part 145 as shown in FIG. 20. Cut-out parts may be formed at at least one corner or all four corners of the OIS driving magnet 245a as a magnet-side fixing part 2451h coupled with the holder-side fixing part 1451j. The cut-out parts may pass through the OIS driving magnet 245a from the first surface to the second surface thereof.

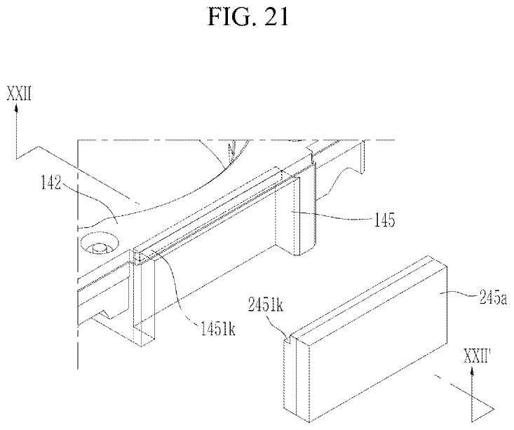

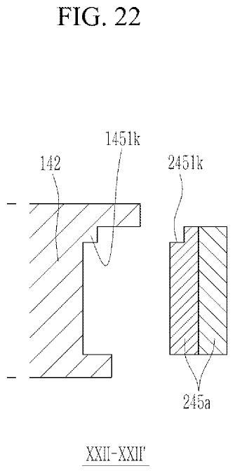

FIG. 21 is an exploded perspective partial view of a lens holder applied to a lens driving apparatus of another embodiment; and FIG. 22 is a partial cross-sectional view taken along the line XXII-XXII′ of FIG. 21.

Referring to FIGS. 21 and 22, a magnet-side fixing part in this embodiment may be a first concave stepped part 2451k formed in one edge of the first surface of the OIS driving magnet 245a facing the outer surface of the lens holder 142. The first concave stepped part 2451k may be formed along an entire edge of the OIS driving magnet 245a. This embodiment exemplifies the first concave stepped part 2451k as being formed along an entire top edge of the OIS driving magnet 245a. However, the first concave stepped part 2451k may also be formed in a bottom edge, a left edge, or a right edge of the of the OIS driving magnet 245a, which also falls within the scope of the present disclosure.

A holder-side fixing part coupled to the first concave stepped part 2451k, which is a magnet-side fixing part of the OIS driving magnet 245a, may include a first convex stepped part 1451k protruding from the surface of the lens holder 142.

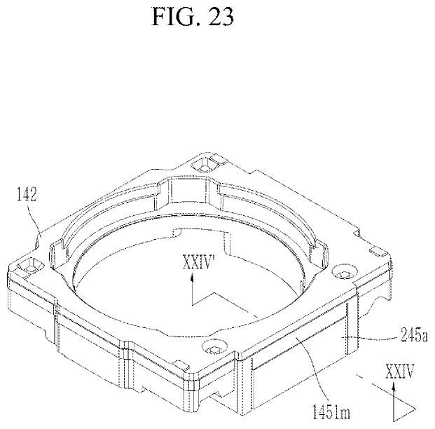

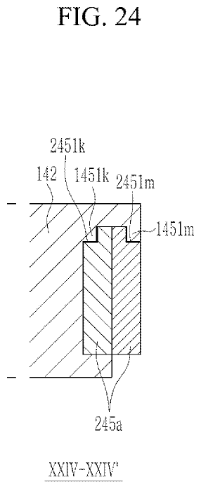

FIG. 23 is an exploded perspective view of a lens holder applied to a lens driving apparatus of another embodiment; and FIG. 24 is a partial cross-sectional view taken along the line XXIV-XXIV′ of FIG. 23.

Referring to FIGS. 23 and 24, a magnet-side fixing part of this embodiment may further include a second concave stepped part 2451n in addition to the first concave stepped part 2451k. The second concave stepped part 2451m may be formed in another edge of the OIS driving magnet 245a that is opposite to the edge in which the first concave stepped part 2451k is formed. The second concave stepped part 2451m may be disposed at a magnetic pole of the OIS driving magnet 245a that is different from a magnetic pole of the OIS driving magnet 245a at which the first concave stepped part 2451k is disposed. That is, the first concave stepped part 2451k and the second concave stepped part 2451m may be respectively formed in an inner top edge and an outer top edge of the OIS driving magnet 245a.

A holder-side fixing part coupled with the second concave stepped part 2451m may be a protruding end 1451m protruding downward in the optical axis direction.

Hereinafter, the description describes a method of manufacturing a lens driving apparatus according to an embodiment with reference to FIGS. 1 through 24.

In the manufacturing method of a lens driving apparatus according to this embodiment, an optical image stabilization (OIS) driving magnet may be coupled with a lens holder 142 when the lens holder 142 is manufactured.

First, a magnet to be coupled with the lens holder 142 may be prepared. A magnetic force of the magnet may be demagnetized in a process of manufacturing the lens holder 142, so an unmagnetized driving magnet that is not magnetized may be prepared.

The unmagnetized driving magnet may be mounted in a lens holder mold. A structure for fixing the unmagnetized driving magnet at a predetermined location may be formed in the lens holder mold. For example, a guide protruding from a surface of the lens holder mold may be formed along an edge of a hole formed in the unmagnetized driving magnet.

The lens holder may be formed by insert injection molding to form holder-side fixing parts 1441 and 1451 respectively coupled with magnet-side fixing parts 2441 and 2451 by injecting an injection material into the lens holder mold in which the unmagnetized driving magnet is mounted. The holder-side fixing parts 1441 and 1451 may have shapes complementary to shapes of the magnet-side fixing parts 2441 and 2451 formed by the insert injection molding. As shown in FIGS. 6 through 17, the magnet-side fixing parts 2441 and 2451 may have a wider cross-sectional area at a second surface of the unmagnetized driving magnet opposite to a first surface of the unmagnetized driving magnet that is adjacent to and coupled to the outer surface of the lens holder 142 than at the first surface, or the magnet-side fixing parts 2441 and 2451 may have a wider cross-sectional area at the second surface than at any point located between the first and second surfaces. In this case, each free end of the holder-side fixing parts 1441 and 1451 may also be formed to have a relatively wide cross-sectional area, thereby increasing a holding force when coupling the unmagnetized driving magnet with the lens holder 142.

The unmagnetized driving magnet coupled with the lens holder may be magnetized after the insert injection molding has been completed. The driving magnet may be magnetized so that the first surface and the second surface have different magnetic poles.

As described above, according to the lens driving apparatus and the method of manufacturing the lens driving apparatus according to the embodiments, it is possible to form a lens driving apparatus in which the lens holder and the driving magnet are integrally coupled with each other by forming the lens holder by insert injection molding with the magnet mounted in the lens holder mold. Therefore, it is possible to form the lens holder coupled with the magnet without any additional process such as a process of manufacturing a yoke or a process of magnet bonding, which leads to a simplified process and a shorter process time, a lower component cost such as a mold cost, and a lower manufacturing cost. It is also possible to reduce appearance defects that may occur due to a foreign material or a bonding material that may occur in the process of magnet bonding. It is also possible to increase a holding force by integrally coupling the lens holder with the magnet by the insert injection molding.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and are not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens driving apparatus comprising:
a lens holder accommodating a lens barrel;
an optical image stabilization (OIS) driving magnet coupled to an outer surface of the lens holder;
a holder-side fixing part protruding from the outer surface of the lens holder; and
a magnet-side fixing part disposed in the OIS driving magnet and coupled with the holder-side fixing part.

2. The apparatus of claim 1, wherein the lens holder and the holder-side fixing part are integrally formed with each other.

3. The apparatus of claim 1, wherein the holder-side fixing part of the lens holder is an insert injection molded part inserted into and fixed to the magnet-side fixing part of the OIS driving magnet by insert injection molding.

4. The apparatus of claim 1, wherein the holder-side fixing part comprises a protruding pillar having a fixed end fixed to the outer surface of the lens holder and a free end protruding outward from the outer surface of the lens holder, and
the magnet-side fixing part comprises a hole into which the protruding pillar is inserted.

5. The apparatus of claim 4, wherein the protruding pillar is tapered so that a cross-sectional area of the protruding pillar at the free end is larger than a cross-sectional area of the protruding pillar at the fixed end.

6. The apparatus of claim 4, wherein the protruding pillar is a bent pillar bent at the free end.

7. The apparatus of claim 6, wherein the magnet-side fixing part is a cut-out part disposed at one edge of the OIS driving magnet.

8. The apparatus of claim 6, wherein the protruding pillar is further bent at the fixed end.

9. The apparatus of claim 4, wherein a smallest cross-sectional area of the protruding pillar is between the fixed end and the free end.

10. The apparatus of claim 9, wherein the protruding pillar is tapered from either one or both of the fixed end and the free end to a point where the pillar has the smallest cross-sectional area.

11. The apparatus of claim 1, wherein the holder-side fixing part comprises at least one outward protrusion protruding outward from the outer surface of the lens holder.

12. The apparatus of claim 1, wherein the magnet-side fixing part comprises a cut-out part disposed at one edge of the OIS driving magnet.

13. The apparatus of claim 1, wherein the magnet-side fixing part comprises a cut-out part disposed at one corner of the OIS driving magnet.

14. The apparatus of claim 1, wherein the magnet-side fixing part comprises a first concave stepped part formed in one edge of the OIS driving magnet facing the outer surface of the lens holder, and
the holder-side fixing part comprises a first convex stepped part coupled with the first concave stepped part of the magnet-side fixing part.

15. The apparatus of claim 14, wherein the magnet-side fixing part further comprises a second concave stepped part formed in another edge of the OIS driving magnet opposite to the edge in which the first concave stepped part is formed.

16. A method of manufacturing a lens driving apparatus, the method comprising:
mounting an unmagnetized optical image stabilization (OIS) driving magnet comprising a magnet-side fixing part in a lens holder mold;
injecting an injection material into the lens holder mold to form an insert injection molded lens holder having a holder-side fixing part coupled with the magnet-side fixing part; and
magnetizing the unmagnetized OIS driving magnet.

17. The method of claim 16, wherein the injecting of the injection material into the lens hold mold forms the holder-side fixing part so that the holder-side fixing part protrudes from an outer surface of the lens holder and fills the magnet-side fixing part.

18. A lens driving apparatus comprising:
a lens holder accommodating a lens barrel;
an optical image stabilization (OIS) driving magnet mounted on the lens holder and comprising a magnet-side fixing part; and
a holder-side fixing part mounted on the lens holder and filling the magnet-side fixing part.

19. The lens driving apparatus of claim 18, wherein the magnet-side fixing part is a hole spaced apart from every edge of the OIS driving magnet and extending through the OIS driving magnet, and
the holder-side fixing part is a protruding pillar protruding from the lens holder and filling the hole.

20. The lens driving apparatus of claim 18, wherein the magnet-side fixing part is a cut-out part formed in an edge of the OIS driving magnet and extending through the OIS driving magnet, and
the holder-side fixing part is a protruding pillar protruding from the lens holder and filling the cut-out part.

21. The lens driving apparatus of claim 18, wherein the magnet-side fixing part is a concave stepped part formed in an edge of the OIS driving magnet and extending partway through the OIS driving magnet, and
the holder-side fixing part is a convex stepped part protruding from the lens holder and filling the concave stepped part.
